(19) United States
(12) Patent Application Publication
(10) Pub. No.: US 2007/0233318 A1
(43) Pub. Date: Oct. 4, 2007

(54) Follow Robot

(76) Inventor: Tianmo Lei, Cupertino, CA (US)

Correspondence Address: TIANMO LEI, 814 BETLIN AVENUE, CUPERTINO, CA, 95014, US

(21) Appl. No.: 11/308,489

(22) Filed: Mar. 29, 2006

(51) Int. Cl. G06F 19/00

(52) U.S. Cl. 700/245

(57) ABSTRACT

A follow robot is disclosed. The follow robot comprises body, head, limbs and muscles same as or proportional with human's body, head, limbs and muscle in shape, size, Specific Gravity (SG) and Center of Gravity (CG). The follow robot's joints are same as or proportional with human's joints and can turn around to reach same angle as human's joints. The follow robot's head, body, limbs, bones and joints possess the same or proportional support ability as human's head, body, limb, bones and joints, and are droved by artificial muscle, step motor, hydraulic pressure component. Many position and distance sensors are mounted on or around a man, which measure any action of the man continuously. These movement signals are collected by a Personal computer (PC) and transmitted to the follow robot. Following these signals, the follow robot repeats every movement of the man, acts exactly same as the man. Many sensors are also mounted on the follow robot; they are eyes, ears, skin and noses of the follow robot. Any thing the follow robot seeing, hearing, feeling and smelling will be converted to digital signal and transmitted to the man by the PC. The man can see, hear, feel and smell any thing around the fellow robot real timely, and respond to it immediately.

### FIELD OF THE INVENTION

The robot actor to perform dance and song, gymnastics, martial art and shadowboxing;

The robot teacher to teach dance and song, gymnastics, martial art, shadowboxing;

The robot nurses of baby, elder and patient;

The robot driver of the ship, vehicle, tank, submarine, even airplane;

The robot worker at danger zone;

The robot safety guarder and soldier;

The machine animal.

### BACKGROUND OF THE INVENTION

The scientists used a manipulator in the early nuclear physics laboratory to avoid the harm from the nuclear radiation. The lab assistant put his fingers into the manipulator out side the transparent partition wall, the manipulator inside the wall will following the movement of the manipulator out side the wall, actually following the finger of the lab assistant, to accomplish the operation that the lab assistant want to do.

In today's tiny cut surgery operation, people use analogous technology. A tiny manipulator, inserting into patient's body through a small cut, follows the movement of the finger of surgery doctor out side the patient's body, to accomplish operations of cutting and sewing.

I call all these manipulators as follow manipulator. Till now, no person extend this concept to whole robot, let the every bones and joints of a robot follows the movement of a man's every bones and joints.

There are many two legs robot also. The inventors want these robots do every thing by themselves. That is very difficult goal. It may be accomplished in the future, but not now. So far, these robots act very clumsy and like a little boy.

### SUMMARY OF THE INVENTION

My invention is let robot follows every action of a man, how to act is take care by the man. This method will greatly reduce the design difficulty of the follow robot, make the follow robot's structure is simple and the cost is low. Another idea is that, when the follow robot has same physique, Specific Gravity (SG) and Center of Gravity (CG) as a human, the follow robot will acts like a human completely. The third idea is that the man get feedback from the follow robot, so, the man can respond to every situation the follow robot are in. The fourth idea is that the communication and interaction between the man and the follow robot is real time.

In my invention, the follow robot comprises body, head, limbs and muscles same as or proportional with human's body, head, limbs and muscle in shape, size, Specific Gravity (SG) and Center of Gravity (CG). The follow robot's joints are same as or proportional with human's joints and can turn around to reach same angle as human's joints. The follow robot's body, head, limbs, bones and joints possess the same or proportional support ability as human's body, head, limb, bones and joints, and are droved by artificial muscle, step motor, hydraulic pressure component. Many position and distance sensors are mounted on or around a man, which measure any action of the man continuously. These movement signals are collected by a Personal Computer (PC) and transmitted to the follow robot. Following these signals, the follow robot repeats every movement of the man, acts exactly same as the man. Many sensors are also mounted on the follow robot; they are eyes, ears, skin and noses of the follow robot. Any thing the follow robot seeing, hearing, feeling and smelling will be converted to digital signal and transmitted to the man by the PC. The man can see, hear, feel and smell any thing around the fellow robot real timely, and respond to it immediately.

As implied by its name, the follow robot only follows the action of a man. The man makes any thinking, analysis, estimate, judgment and decision. But, the ability of the follow robot is very strong. Only talk about stand up and walk using two legs, as long as the man not fall down, the follow robot will not fall down, because the follow robot has same Specific Gravity (SG) and Center of Gravity (CG) as the man. So, let the follow robot to dance as extremely clever and wonderfully as human is easy thing, but to any other existing robot, it is nearly impossible. This is because that, in my invention, anything is looked after by a man, the follow robot is only following.

### BRIEF DESCRIPTION OF THE DRAWINGS

FIG. 1 shows a follow robot performs shadowboxing following a girl.

FIG. 2 shows a follow robot how to act all alone.

### DETAILED DESCRIPTION OF THE INVENTION

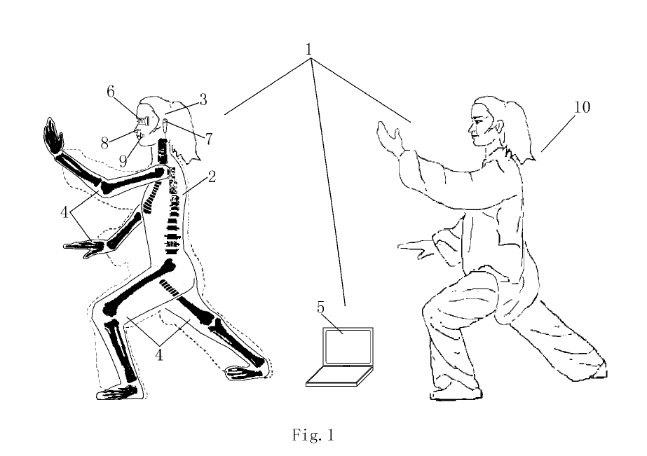

As shown in FIG. 1, the follow robot 1 comprises body 2, head 3, limbs 4, including all bones, joints and artificial muscles, same as or proportional with human in shape, size, Specific Gravity (SG) and Center of Gravity (CG), and can deftly move around as human. The follow robot's joints are same as or proportional with human joints and can turn around to reach the same angle as human's joints. The follow robot's body, head, limbs, bones and joints, have the same or proportional support ability as human's and are driven by artificial muscle, step motor, hydraulic pressure component. The action of the follow robot is controlled by a PC 5.

The follow robot comprises digital camera eyes 6, which can turn around as human's eyes and record the video. The follow robot comprises many touch press force sensor on its skin, can measure the touch press force. The follow robot has sound sensor 7 and smell sensor 8, can record the surrounding sound and smell. The PC 5 collects all of these signals and transmits to a man.

Many position and distance sensors are mounted on or around a man 10, which can measure the movement and location of every bone and joint of the man. The man wears two eye-ball trackers, which can measure the direction of the eyesight. These signals are collected by the PC 5 and transmitted to the follow robot. Following these signals, the follow robot acts exactly like the man, including the rotation of its digital camera eyes. The man can speak via the robot's mouth, speaker 9.

The man wear a head mounted LCD display to see the video come from the follow robot's digital camera eyes; because the movement of the follow robot's digital camera eyes follows the movement of the man's eyes, the man can see any thing he want to see around the follow robot.

Many electric/force transducer are affixed on the skin of the man, the man can feel the touch press force produced by the press force signal come from the follow robot's touch press force/electric sensors.

The man wear an earphone, can hear the sound recorded by the robot.

The man can smell the scent captured by the robot's smell sensor using a smell generator, which controlled by the smell signal come from the robot.

Any movement of any part of a man's body will be measured by sensor mounted on or around the man. The eyeball trackers will measure the man's eyeball's movement. These movement signals will be transmitted to follow robot real timely. These movement signals will drive the follow robot to act as the man. Any signal detected by sensors on the follow robot will be send to man real timely too, let the man to know every thing around the follow robot and to decide to how to act next.

This way, the follow robot does every thing the man is doing, at front, at danger place, follows a man, who makes any thinking, analysis, estimate, judgment and decision, at back, at safe place.

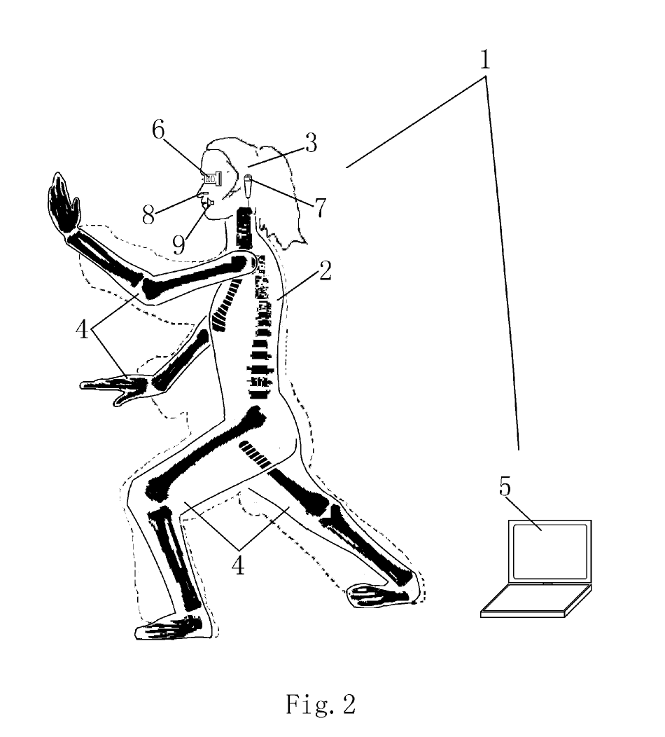

The FIG. 2 shows the follow robot how to act all alone. When follow robot dances, it actually executes the instruction come from the PC according a man's dance action. To store these instructions in the PC's memory will store the dance action instructions permanently. Next time, not need to follows a dancer, only read out of stored dance instructions from the PC's memory and send to the follow robot, the robot will dance again same as previous time exactly. This way, the follow robot can act as a very good teacher, even better than human teacher, because every time the action will never be changed a bit. Same way, the follow robot can be a good dance actor to perform the ethereally bewitch dance again and again never tired and never go out of form.

What is claimed is:

1. A follow robot comprises:
A body, head, limbs, bones, joints and artificial muscles same as or proportional with human's body, head, limbs, bones, joints and muscles in shape, size, Specific Gravity and Center of Gravity; the said joints can turn around to reach the same angle as human's joints; the said body, head, limbs, bones and joints possess the same or proportional support ability as human's body, head, limbs, bones, joints and are driven by the said artificial muscle, step motor or hydraulic pressure component;
Two digital camera eyes, which can turn around as human's eyes and record the digital video;
Many touch press force sensors, which are affixed at the said body, head and limbs, can measure the touch press force and convert to touch press force digital signal;
Two sound sensors, which can convert surrounding sound to digital sound signal;
A smell sensor, which can convert the surrounding smell to digital smell signal;
A speaker to play sound;
A Personal Computer (PC), which collects said digital video, said touch press force digital signal, said digital sound signal, said digital smell signal and transmits these signal to a man;
Many movement sensors are mounted on or around the said man, which can measure the movement and position of the body, head, limbs, bones and joints of the said man, the said PC collects and transmits these movement signals to the said follow robot and control the said follow robot's body, head, limbs, bones, joints and artificial muscles to act exactly like the said man's action real timely;
Two eye-ball trackers mounted on the said man's head, which can measure the direction of the eye sight of the said man, the said PC transmits the said eye sight direction signals to the said follow robot and control the said follow robot's digital camera eye to turn around exactly like the said man's eyes real timely;
A head mounted LCD display mounted on the said man's head to display the said digital video come from the said follow robot's digital camera eyes; so, the said man can see any thing he want to see around the said follow robot real timely;
Many electric/force transducers, which are affixed on the skin of the said man; so, the said man can feel the touch press force produced by the said press force signal come from the said follow robot;
Two earphones to play the said digital sound signal recorded by the said follow robot;
A smell converter to convert the said digital smell signal comes from the said follow robot to the scent.

2. A follow robot comprises:
A body, head, limbs, bones, joints and artificial muscles same as or proportional with human's body, head, limbs, bones, joints and muscles in shape, size, Specific Gravity and Center of Gravity; the said joints can turn around to reach the same angle as human's joints; the said body, head, limbs, bones and joints possess the same or proportional support ability as human's body, head, limbs, bones, joints and are driven by the said artificial muscle, step motor or hydraulic pressure component;
Two digital camera eyes, which can turn around as human's eyes and record the digital video;
Many touch press force sensors, which are affixed at the said body, head and limbs, can measure the touch press force and convert to touch press force digital signal;
Two sound sensors, which can convert surrounding sound to digital sound signal;
A smell sensor, which can convert the surrounding smell to digital smell signal;
A speaker to play sound;
A Personal Computer (PC), which collects said digital video, said touch press force digital signal, said digital sound signal, said digital smell signal and transmits these signal to a man;
Many movement sensors are mounted on or around the said man, which can measure the movement and position of the body, head, limbs, bones and joints of the said man, the said PC collects and transmits these movement signals to the said follow robot and control the said follow robot's body, head, limbs, bones, joints and artificial muscles to act exactly like the said man's action real timely;
Two eye-ball trackers mounted on the said man's head, which can measure the direction of the eye sight of the said man, the said PC transmits the said eye sight direction signals to the said follow robot and control the said follow robot's digital camera eye to turn around exactly like the said man's eyes real timely;
A head mounted LCD display mounted on the said man's head to display the said digital video come from the said follow robot's digital camera eyes; so, the said man can see any thing he want to see around the said follow robot real timely;
Many electric/force transducers, which are affixed on the skin of the said man; so, the said man can feel the touch press force produced by the said press force signal come from the said follow robot;
Two earphones to play the said digital sound signal recorded by the said follow robot;
A smell converter to convert the said digital smell signal comes from the said follow robot to the scent;
To store the said movement signal produced by said movement sensors of the said man in the said PC's memory, will store the said man's action permanently; to read out the said movement signal from the said PC's memory and to transmit to the said follow robot, the said follow robot will act again same as previous time exactly all alone.

3. A follow animal comprises:
A body, head, limbs, bones, joints and artificial muscles same as or proportional with an animal's body, head, limbs, bones, joints and muscles in shape, size, Specific Gravity and Center of Gravity; the said joints can turn around to reach the same angle as the said animal's joints; the said body, head, limbs, bones and joints, possess the same or proportional support ability as said animal's body, head, limbs, bones and joints, and are driven by the said artificial muscle, step motor, hydraulic pressure component;
Many movement sensors are mounted on or around the a real animal, which can measure the movement and position of the body, head, limbs, bones and joints of the said real animal; a Personal Computer collects and transmits these movement signals to the said follow animal and control the said follow animal to act exactly like the said real animal's action real timely;
To store the said movement signal produced by said movement sensors of the said real animal in the said PC's memory, will store the said real animal's action permanently; to read out the said movement signal from the said PC's memory and to transmit to the said follow animal, the said follow animal will act again same as previous time exactly;
A microphone mounted on the real animal to record the said real animal's sound;
A speaker mounted on the follow animal to play the said real animal's sound.
